(19) United States
(12) Patent Application Publication
(10) Pub. No.: US 2005/0129203 A1
(43) Pub. Date: Jun. 16, 2005

(54) Method and apparatus for broadcasting time-of-day data to networked consumer product devices

(76) Inventors: Albert Fitzgerald Elcock, Havertown, PA (US); Thomas Kister, Chalfont, PA (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/736,263

(22) Filed: Dec. 15, 2003

(51) Int. Cl. H04M 1/56; H04M 15/06

(52) U.S. Cl. 379/142.11

(57) ABSTRACT

A method and apparatus 100 provided for providing time-of-day data to a networked device 102-107. The method begins by receiving a telephony signal that includes time-of-day data and extracting the time-of-day data from the telephony signal. The time-of-day data is then transmitted to the networked device 102-107 over a communication network.

### FIELD OF THE INVENTION

The present invention relates generally to networked devices such as networked consumer appliances and more particularly to a method and apparatus for broadcasting time-of-day data to networked devices.

### BACKGROUND OF THE INVENTION

As the Internet continues to grow and become more pervasive in homes, more and more consumer products are expected to be connected to the Internet and interconnected with one another over local area networks (LANs). For example, an Internet-equipped refrigerator can maintain an inventory of groceries and re-order when necessary. An Internet-equipped alarm clock can communicate with a source of current weather and road conditions and determine the correct time to wake up someone. Likewise, if the alarm clock is networked with a bedroom lamp, it can turn on the lamp at the appropriate time.

Networked devices such as refrigerators, clocks, lamps, televisions and the like are examples of networked appliances, which may be defined as dedicated function consumer devices containing a networked processor. That is, a networked appliance is any non-general purpose device (i.e., not a PC, PDA, etc.) that has a network connection. As such appliances become more and more interconnected with one another it will become more and more important for them to all be synchronized to the correct time. Moreover, it would be highly convenient for consumers if they did not have to manually set the time on each and every network device.

### SUMMARY OF THE INVENTION

In accordance with the present invention, a method and apparatus is provided for providing time-of-day data to a networked device. The method begins by receiving a telephony signal that includes time-of-day data and extracting the time-of-day data from the telephony signal. The time-of-day data is then transmitted to the networked device over a communication network.

In accordance with one aspect of the invention, the telephony signal includes ICLID data.

In accordance with another aspect of the invention, the telephony signal is received over a PSTN transmission network.

In accordance with another aspect of the invention, the telephony signal is received over a cellular network.

In accordance with another aspect of the invention, the telephony signal is received over a Voice-over-IP network.

In accordance with another aspect of the invention, the networked device includes a networked appliance.

In accordance with another aspect of the invention, the communication network is a LAN.

In accordance with another aspect of the invention, the time-of-day data is transmitted in accordance with a network time protocol.

In accordance with another aspect of the invention, the network time protocol is the Network Time Protocol.

In accordance with another aspect of the invention, the network time protocol is the Simple Network Time Protocol.

In accordance with another aspect of the invention, an apparatus provides time-day data to at least one networked device. The apparatus includes a data receiver for receiving a telephony signal that includes time-of-day data and a processor for transforming the time-of-day data in accordance with a network protocol. The apparatus also includes an interface arrangement for transmitting the time-of-day data to the networked device over a communication network.

### BRIEF DESCRIPTION OF THE DRAWING

FIG. 1 is a schematic diagram illustrating a central telephony on-hook data receiver that can receive time data from a telephony service provider and communicate such data to various networked devices in accordance with the present invention.

FIG. 2 shows a block diagram of one embodiment of the central telephony on-hook data receiver that is employed in the present invention.

### DETAILED DESCRIPTION

The present inventors have recognized that networked devices such as networked appliances as well as general purpose devices such as PCs can be readily synchronized to the correct time using commonly available telephony services that are or can be made available in most residences. In particular, the enhanced telephony subscriber service known as Incoming Caller Line Identification (“ICLID”), which is commonly referred to as Caller ID, provides a variety of data about a caller including the time and date of the call. In the present invention the time-of-day data is extracted from the ICLID data by a central networked device that can communicate the time data to other devices that are connected to the network. The networked device receiving the ICLID data and extracting the time data may be a stand-alone receiver or it may be incorporated into another device that serves as a central gateway to other networked devices in the home. Such a central gateway may be, for example, a conventional PC, a television set-top box, or a media center that incorporates interfaces for accessing digital music and photos, watching and recording television shows and viewing DVD movies.

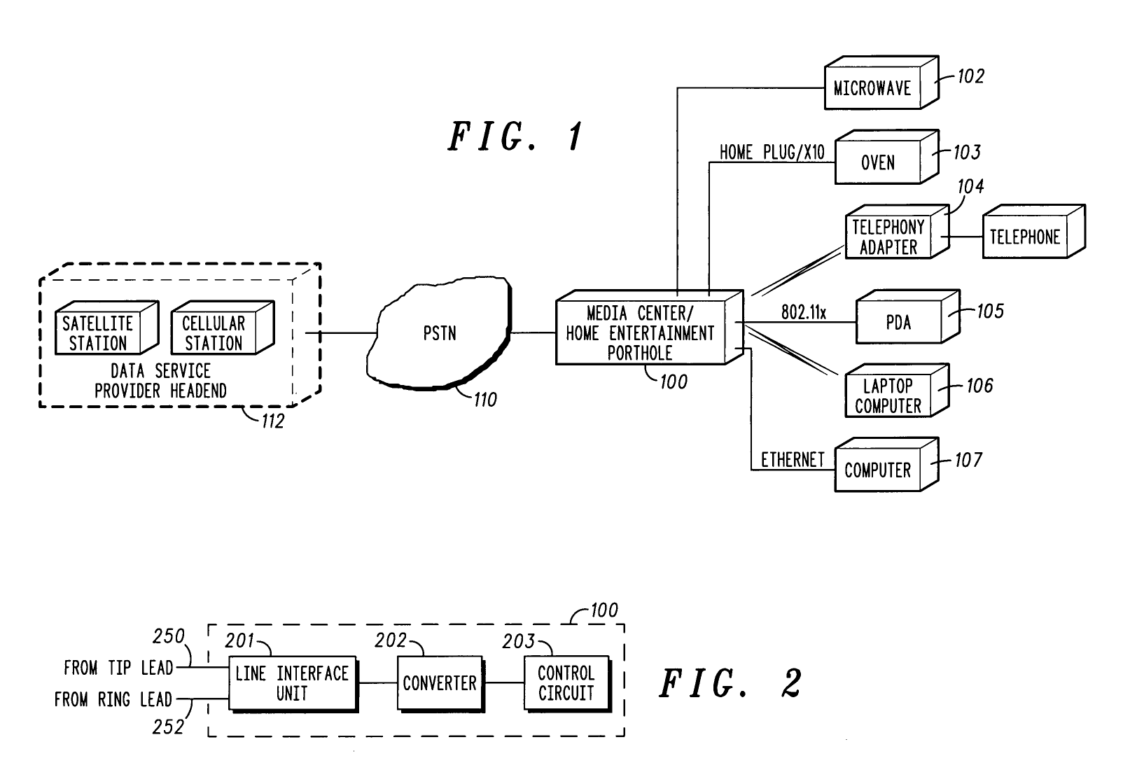

FIG. 1 is a schematic diagram illustrating the manner in which a central telephony on-hook data receiver 100 can receive time data from a telephony service provider 112 and communicate such data to various networked devices 102-107 over a LAN in accordance with the present invention. For purposes of illustration only the central telephony data receiver 100 is depicted in FIG. 1 as being incorporated in a media center or gateway. The networked devices 102-107 may communicate with the data receiver 100 over a conventional port such as a serial, infrared, USB, Bluetooth, IEEE 802.11, or IEEE 1394 port, for example. In addition, Powerline Communication Technology (PCL) may be used to communicate with networked appliances such as the conventional and microwave ovens 103 and 102 shown in FIG. 1. Example of PCL protocols that may be employed include, for example X.10, Home Plug, Home Plug and Play, and CEBus.

The telephony data receiver 100 is capable of obtaining the ICLID data from a telephone call before the telephone call is answered. The ICLID data is received during the silent interval following the first ring of the telephone call. The silent interval between ring signals transmitted from a telephone central office is generally about four seconds. During this interval the central office transmits a serial data message in the form of a frequency shift keyed (FSK) signal.

FIG. 2 shows a block diagram of one embodiment of the central telephony on-hook data receiver 100 that is employed in the present invention. In this particular embodiment of the invention the telephony time data is received over PSTN transmission line as part of the ICLID data. Of course, those of ordinary skill in the art will recognize that the telephony data may be delivered to the data receiver 100 over other transmission means including cellular and Voice-Over-IP networks, provided that such telephony data includes the desired time data in a manner that allows it to be extracted.

The data receiver 100 includes a line interface unit 201, converter 202 and control circuit 203. The FSK signal that represents the ICLID data is received in a balanced manner on the tip and ring leads 250 and 252 of the data receiver 100. Line interface unit 201 amplifies the FSK signal and attenuates the ringing signals. Converter 202 includes a frequency shift keyed modem that converts the FSK signal from the line interface unit 201 to a serial bit stream representation of the data message. Control circuit 201 includes a microprocessor that interprets the data message from the converter 202. Central telephony data receiver 100 is well known in the art. Additional details concerning such a receiver may be found, for example, in U.S. Pat. No. 4,582,956.

Referring again to FIG. 1, the time-of-day data extracted by the data receiver 100 is transmitted to the various networked devices over the LAN. Prior to transmission, the time data is formatted in accordance with any appropriate network time protocol. One example of a protocol that may be employed is the Network Time Protocol (NTP), which is a time synchronization protocol that allows computers to be synchronized to a time standard. NTP is a TCP/IP network protocol that defines a set of procedures for synchronizing clocks connected to a network. NTP measures delays within the network and within the algorithms on the machine on which it is running. The protocol uses a returnable-time design in which a distributed subnet of time servers operating in a self-organizing, hierarchical master/slave configuration synchronizes local clocks within a subnet. Instead of the NTP protocol, a simplified version called Simple Network Time Protocol (SNTP) may be employed. SNTP uses a TCP/IP packet structure like NTP but with simpler algorithms, thereby providing reduced precision that nevertheless may generally be sufficient for the synchronization of time on typical consumer appliances.

In the present invention, the control circuit 203 in which the time-of-day data is located effectively serves as the time server and the networked devices serve as clients. The control circuit 203 may also be employed to format the time data in accordance with the appropriate protocol required for transmission to the networked devices. Alternatively, this function can be performed by another dedicated circuit or processor.

If the LAN depicted in FIG. 1 is connected to the Internet, either via the data receiver 100 itself or through one of the other networked devices, the time of day data could be extracted either in accordance with the present invention or from a time server connected to the Internet. In this case the data receiver 100 can determine which time source to use in accordance with priorities established by the user.

Although various embodiments are specifically illustrated and described herein, it will be appreciated that modifications and variations of the present invention are covered by the above teachings and are within the purview of the appended claims without departing from the spirit and intended scope of the invention. For example, the various components of the present invention may be embodied in hardware, software, or a combination of both.

1. A method for providing time-of-day data to a networked consumer product device, said method comprising the steps of:
receiving a telephony signal that includes time-of-day data;
extracting the time-of-day data from the telephony signal; and
transmitting the time-of-day data to the networked consumer product device 102-107 over a communication network.

2. The method of claim 1 wherein said telephony signal includes ICLID data.

3. The method of claim 1 wherein the telephony signal is received over a PSTN transmission network 110.

4. The method of claim 1 wherein the telephony signal is received over a cellular network 110.

5. The method of claim 1 wherein the telephony signal is received over a Voice-over-IP network 110.

6. The method of claim 1 wherein the networked device includes a networked appliance 102-103.

7. The method of claim 1 wherein said communication network is a LAN.

8. The method of claim 7 wherein the time-of-day data is transmitted in accordance with a network time protocol.

9. The method of claim 8 wherein the network time protocol is the Network Time Protocol.

10. The method of claim 8 wherein the network time protocol is the Simple Network Time Protocol.

11. An apparatus for providing time-day data to at least one networked consumer product device, comprising:
a data receiver 100 for receiving a telephony signal that includes time-of-day data;
a processor 203 for transforming the time-of-day data in accordance with a network protocol;
an interface arrangement 203 for transmitting the time-of-day data to the networked consumer product device over a communication network.

12. The apparatus of claim 11 wherein said telephony signal includes ICLID data.

13. The apparatus of claim 11 wherein the telephony signal is received over a PSTN transmission network 110.

14. The apparatus of claim 11 wherein the telephony signal is received over a cellular network 110.

15. The apparatus of claim 11 wherein the telephony signal is received over a Voice-over-IP network 110.

16. The apparatus of claim 11 wherein the networked device includes a networked appliance 102-103.

17. The apparatus of claim 11 wherein said communication network is a LAN.

18. The apparatus of claim 11 wherein the time-of-day data is transmitted in accordance with a network time protocol.

19. The apparatus of claim 18 wherein the network time protocol is the Network Time Protocol.

20. The apparatus of claim 18 wherein the network time protocol is the Simple Network Time Protocol.
